(19) United States
(12) Patent Application Publication
(10) Pub. No.: US 2025/0170431 A1
(43) Pub. Date: May 29, 2025

(54) FALL ARREST SYSTEM

(71) Applicant: Honeywell Safety Products USA, Inc., Charlotte, NC (US)

(72) Inventors: Tomáš DAMEK, Brno (CZ); Zdenek KOLBÁBEK, Brno (CZ); Pavlína VESELÁ, Brno (CZ); Stanislav HEMALA, BuÄovice (CZ); Václav HRUZA, Brno (CZ)

(21) Appl. No.: 18/961,896

(22) Filed: Nov. 27, 2024

Related U.S. Application Data
(60) Provisional application No. 63/603,389, filed on Nov. 28, 2023.

(51) Int. Cl. A62B 1/10

(52) U.S. Cl. CPC A62B 1/10

(57) ABSTRACT

A fall arrest system is disclosed. The fall arrest system comprises a plurality of pulleys and a plurality of holders. At least one of the plurality of pulleys comprises at least one centrifugal brake. Each holder is being coupled to a pulley of the plurality of pulleys and configured to mount the respective pulley onto a mounting area of a structure or the ground. Further, at least one pre-tensioned rope is wrapped around the plurality of pulleys and configured to rotate along the plurality of pulleys. Thereafter, at least one coupling hook is rigidly coupled to the at least one pre-tensioned rope.

### CROSS-REFERENCE TO RELATED APPLICATIONS

The present application is a non-provisional of U.S. Provisional Application No. 63/603,389, filed Nov. 28, 2023, which is hereby incorporated by reference in its entirety.

### TECHNOLOGICAL FIELD

The present application is related to fall arrest systems. More particularly, the application relates to fall arrest systems that provide 360-degrees movement to a user in various scenarios or environments.

### BACKGROUND

Fall protection systems are essential for maintaining safety of a user while climbing heights, whether for leisure or work purposes. The fall protection systems are critical for ensuring safety of users who perform tasks at heights. To function effectively, the fall protection systems are able to move freely along a cable to allow for unrestricted vertical and horizontal movement, while also allowing for fast and efficient activation of a braking system without causing damage or injury to the user. Existing fall arrest systems have a limited range of movement for the user in horizontal and vertical directions. Such fall arrest systems are implemented in two different set-ups and the user can only move within a range of ±20 degrees horizontally and ±15 degrees vertically. Such operation is complex due to two separate arrangements i.e., horizontal and vertical. Therefore, the existing fall arrest system is time consuming and operations can only be performed within the limited range. To comply with restricted movement and safety standards, it becomes essential to install only one arrangement instead of two separate arrangements over a structure. Therefore, a need remains to address these limitations in the existing fall arrest system design and standard compliance to enhance the user safety.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### SUMMARY OF THE DISCLOSURE

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, a fall arrest system is disclosed. The fall arrest system comprises a plurality of pulleys and at least one of the plurality of pulleys comprises at least one centrifugal brake. Further, the fall arrest system comprises a plurality of holders and each holder is coupled to a pulley of the plurality of pulleys and configured to mount the respective pulley onto a mounting area of a structure or the ground. Further, the fall arrest system comprises at least one pre-tensioned rope that is wrapped around the plurality of pulleys and is configured to rotate along the plurality of pulleys. Further, the fall arrest system comprises at least one coupling hook that is rigidly coupled to the at least one pre-tensioned rope.

In some embodiments, at least one auxiliary pulley is arranged with at least one of the plurality of pulleys and is configured to maintain contact of the at least one pre-tensioned rope with the plurality of pulleys.

In some embodiments, the at least one centrifugal brake actuates automatically by utilizing centrifugal forces, to prevent free fall of the user from the mounting area.

In some embodiments, each of the plurality of holders is configured to be mounted to the respective mounting area regardless of the orientation of the respective mounting area.

In some embodiments, at least one tensioner is installed with the at least one of the plurality of pulleys and configured to maintain alignment and tension of the at least one pre-tensioned rope. In some embodiments, the at least one tensioner has a spring loaded arm configured to apply pressure and align the at least one pre-tensioned rope along the plurality of pulleys. In some embodiments, at least one tensioner sensor is coupled to the at least one tensioner and configured to measure tension applied over the at least one pre-tensioned rope.

In some embodiments, the at least one coupling hook has at least two annular sections, at least one annular section is rigidly coupled to the at least one pre-tensioned rope and the other annular section is detachably coupled to at least one lanyard. In some embodiments, the at least one lanyard is configured to attach the user with the at least one coupling hook. In some embodiments, the at least one coupling hook is referred as a Carabiner.

In some embodiments, the at least one lanyard is integrated with a shock absorber that is configured to absorb kinetic energy experienced by the user in the case of a fall.

In some embodiments, at least one of the plurality of holders is coupled to the mounting area that is oriented at a first angle relative to a horizontal plane and another one of the plurality of holders is coupled to the mounting area that is oriented at a second angle relative to the horizontal plane. The first angle is at least 15 degrees greater than the second angle.

In various example embodiments, a fall arrest system is disclosed. The fall arrest system comprises a plurality of pulleys and at least one of the plurality of pulleys comprises at least one centrifugal brake. Further, the fall arrest system comprises a plurality of holders and each holder is being coupled to a pulley of the plurality of pulleys and configured to mount the respective pulley onto a mounting area of a structure or the ground. Further, at least one pre-tensioned rope is wrapped around the plurality of pulleys and configured to rotate along the plurality of pulleys. The fall arrest system further comprises at least one tensioner coupled to at least one of the plurality of pulleys and configured to maintain tension in the at least one pre-tensioned rope. Thereafter, the at least one coupling hook is rigidly connected to the at least one pre-tensioned rope.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1A illustrates a fall arrest system, in accordance with an example embodiment of the present disclosure;

FIG. 1B illustrates a sectional view of the fall arrest system, in accordance with an example embodiment of the present disclosure;

FIG. 2 illustrates an isometric view of at least one pulley, in accordance with an example embodiment of the present disclosure;

FIG. 3A illustrates a perspective view of at least one coupling hook rigidly coupled with the at least one rope, in accordance with an example embodiment of the present disclosure;

FIG. 3B illustrates another sectional view of the fall arrest system with the at least one coupling hook, in accordance with an example embodiment of the present disclosure;

FIG. 3C illustrates a lanyard to be coupled to the at least one coupling hook, in accordance with an example embodiment of the present disclosure;

FIG. 4 illustrates an isometric view of the fall arrest system having the at least one pre-tensioned rope wrapped around the plurality of pulleys with at least one auxiliary pulley to maintain contact of the at least one pre-tensioned rope with the plurality of pulleys, in accordance with an example embodiment of the present disclosure;

FIG. 5 illustrates a tensioner, in accordance with an example embodiment of the present disclosure;

FIG. 6 illustrates an exemplary scenario of the fall arrest system installed over a structure, in accordance with an example embodiment of the present disclosure;

FIGS. 7A-7B illustrate an exemplary scenario of the fall arrest system welded on a beam, in accordance with an example embodiment of the present disclosure;

FIG. 8 illustrates another exemplary scenario of the fall arrest system installed on a railway track, in accordance with an example embodiment of the present disclosure;

FIG. 9 illustrates another exemplary scenario of the fall arrest system installed on a slope structure, in accordance with an example embodiment of the present disclosure; and

FIG. 10 illustrates another exemplary scenario of the fall arrest system installed on a bridge structure, in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of fall arrest systems. Embodiments may be configured to provide 360° movement to a user in various scenarios or environments such as repair works, inspection works, welding works, etc. Embodiments may provide a system for climbing over various structures including bridges, railway tracks, buildings, poles etc. Embodiments may comprise a centrifugal brake that actuates automatically during the fall of the user. Further, embodiments may prevent the user from falling and prevent any possible injuries during the fall. Embodiments may be attached to a wall or stable ground that does not have a range limitation and may be used in 360° directions.

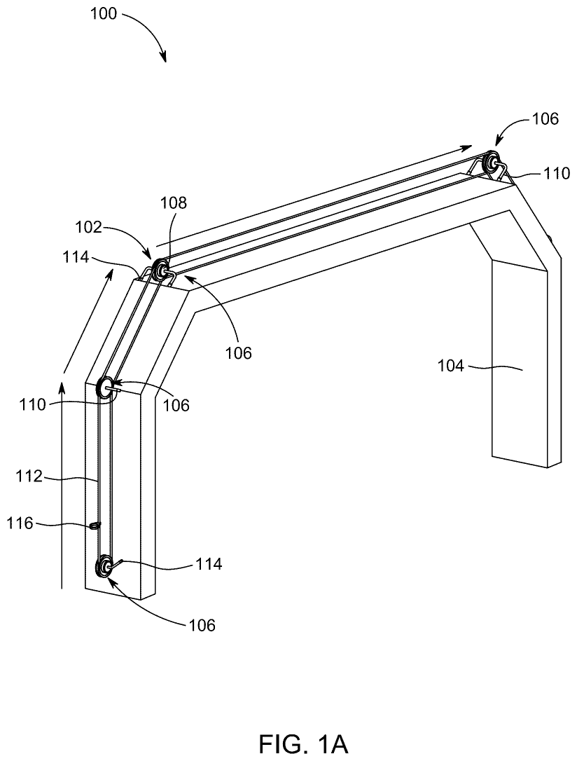

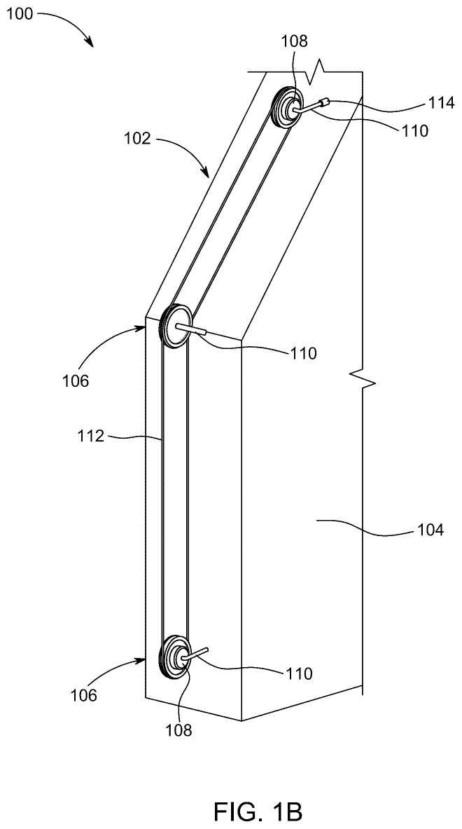

FIG. 1A illustrates an example embodiment of a fall arrest system 100, in accordance with an example embodiment of the present disclosure. FIG. 1A is described in conjunction with FIG. 1B.

The fall arrest system 100 may be mounted over a mounting area 102 of a structure 104. In some embodiments, the mounting area 102 may be a surface or a support beam for a building under construction, a surface on the side of a bridge, a surface under a bridge, a wall, a ceiling, a surface on a railroad track etc. In some other embodiments, the fall arrest system 100 may be attached to a stable ground. The fall arrest system 100 may comprise a plurality of pulleys 106, at least one centrifugal brake 108, a plurality of holders 110, at least one pre-tensioned rope 112, at least one tensioner 114, and at least one coupling hook 116. The plurality of pulleys 106 may be installed over the mounting area 102.

Further, at least one of the plurality of pulleys 106 may be coupled with the at least one centrifugal brake 108. The at least one centrifugal brake 108 may be actuated automatically by utilizing centrifugal forces to prevent free fall of a user from the mounting area 102. Further, the plurality of holders 110 may be coupled to the plurality of pulleys 106. In some embodiments, each of the plurality of holders 110 may mount respective pulley of the plurality of pulleys 106 onto the mounting area 102 of the structure 104 or the ground. In some other embodiments, each of the plurality of holders 110 may be configured to be mounted to the respective mounting area 102 regardless of the orientation of the respective mounting area 102. Stated differently, each of the plurality of holders 110 may be configured to be mounted to a respective mounting area 102, which can have a surface that extends at any angle (e.g., 0-360 degrees) relative to the horizontal plane. For example, at least one of the plurality of holders 110 can be mounted to a mounting area 102 that has a surface that extends at a 90 degree angle, such as a vertical wall. At least one of the plurality of holders 110 can be mounted to a mounting area 102 that has a surface that extends at a 180 degree angle, such as a horizontally-extending ceiling. At least one of the plurality of holders 110 can be mounted to a mounting area 102 that has a surface that extends at a 0 degree angle, such as horizontally-extending ground or floor.

In various examples, at least one of the plurality of holders 110 can be mounted to a mounting area 102 that has a surface that extends at an angle that is less than 45 degrees relative to the horizontal plane and/or at least one of the plurality of holders 110 can be mounted to a mounting area 102 that has a surface that extends at an angle that is at least 45 degrees and up to 90 degrees and/or at least one of the plurality of holders 110 can be mounted to a mounting area 102 that has a surface that extends at an angle that is at least 90 degrees and up to 135 degrees and/or at least one of the plurality of holders 110 can be mounted to a mounting area 102 that has a surface that extends at an angle that is at least 135 degrees and up to 180 degrees and/or at least one of the plurality of holders 110 can be mounted to a mounting area 102 that has a surface that extends at an angle that is at least 180 degrees and up to 225 degrees and/or at least one of the plurality of holders 110 can be mounted to a mounting area 102 that has a surface that extends at an angle that is at least 225 degrees and up to 270 degrees and/or at least one of the plurality of holders 110 can be mounted to a mounting area 102 that has a surface that extends at an angle that is at least 270 degrees and up to 315 degrees and/or at least one of the plurality of holders 110 can be mounted to a mounting area 102 that has a surface that extends at an angle that is at least 315 degrees and up to 360 degrees.

In some embodiments, the at least one of the plurality of holders 110 may be coupled to the mounting area 102 that may be oriented at a first angle relative to a horizontal plane and another one of the plurality of holders 110 may be coupled to the mounting area 102 that may be oriented at a second angle relative to the horizontal plane. In some embodiment, the first angle may be at least 15 degrees greater than the second angle.

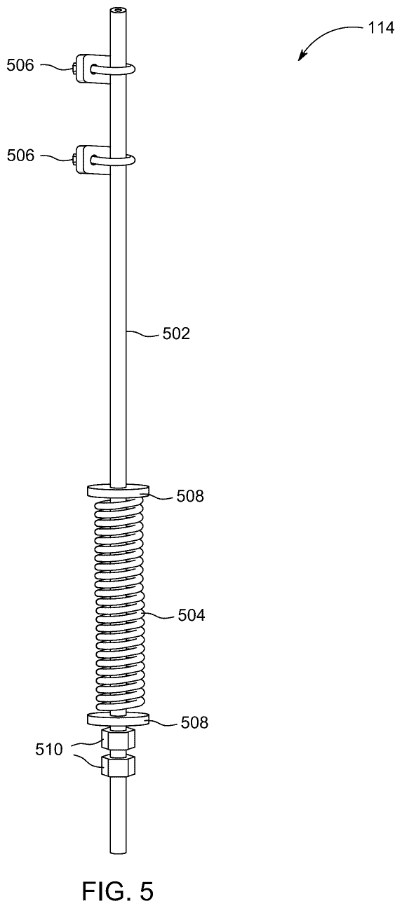

Further, the at least one pre-tensioned rope 112 may be wrapped around the plurality of pulleys 106. The at least one pre-tensioned rope 112 may be configured to rotate along the plurality of pulleys 106. The at least one pre-tensioned rope 112 may be tensioned using the at least one tensioner 114. The at least one tensioner 114 may be installed with the at least one of the plurality of pulleys 106. The at least one tensioner 114 may be configured to maintain alignment and tension of the at least one pre-tensioned rope 112. The at least one tensioner 114 is described in greater detail in conjunction with FIG. 4B. It may be noted that the at least one pre-tensioned rope 112 may be tensioned while loading over the plurality of pulleys 106. It may also be noted that the at least pre-tensioned rope 112 may be tensioned after installed over the plurality of pulleys 106. In some embodiments, the at least one pre-tensioned rope 112 may include a cable or a rope having enough strength to withstand stress developed during tensioning. It will be apparent that thickness of the at least one pre-tensioned rope 112 may vary according to dimensions of the plurality of pulleys 106.

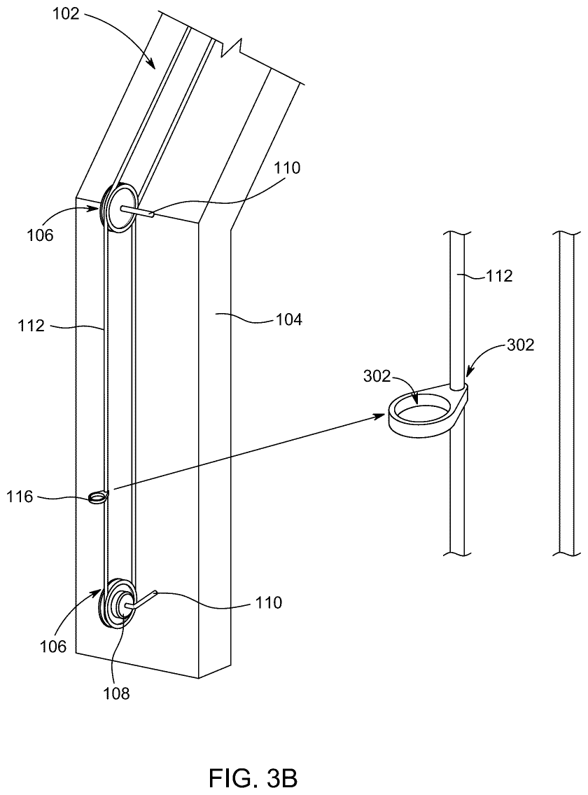

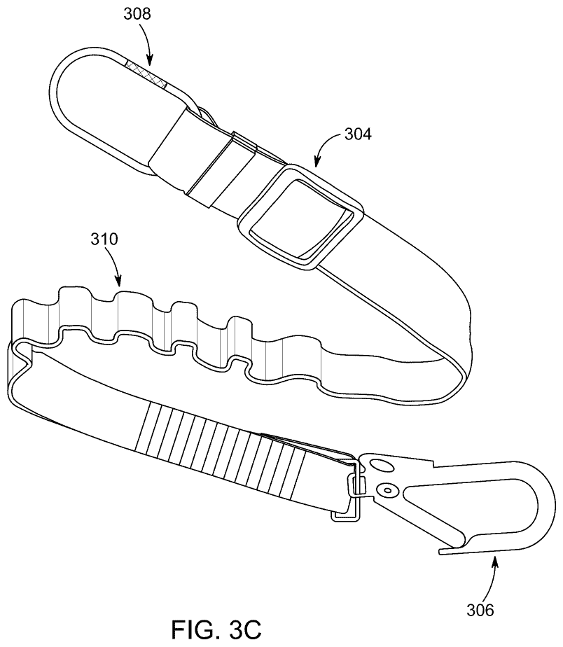

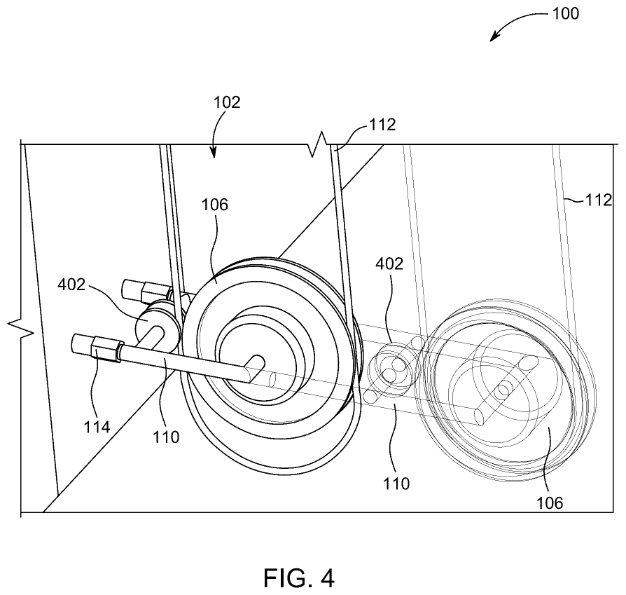

Referring to FIG. 1A, the at least one coupling hook 116 may be rigidly coupled to the at least one pre-tensioned rope 112. The at least one coupling hook 116 may be coupled to a lanyard (e.g., lanyard 304 of FIG. 3C) that may be attached to the user. The at least one coupling hook 116 allows the user to freely slide along the at least one pre-tensioned rope 112. In some embodiments, the at least one coupling hook 116 may be referred as a Carabiner. It may be noted that rotation of the at least one pre-tensioned rope 112 over the plurality of pulleys 106 may provide 360-degrees movement to the user and the user may travel from one end to another end over the mounting area 102 of the structure 104 freely without any restriction. In may be noted that the at least one pre-tensioned rope 112 over the plurality of pulleys 106 may provide vertical and horizontal movement to the user over the structure 104.

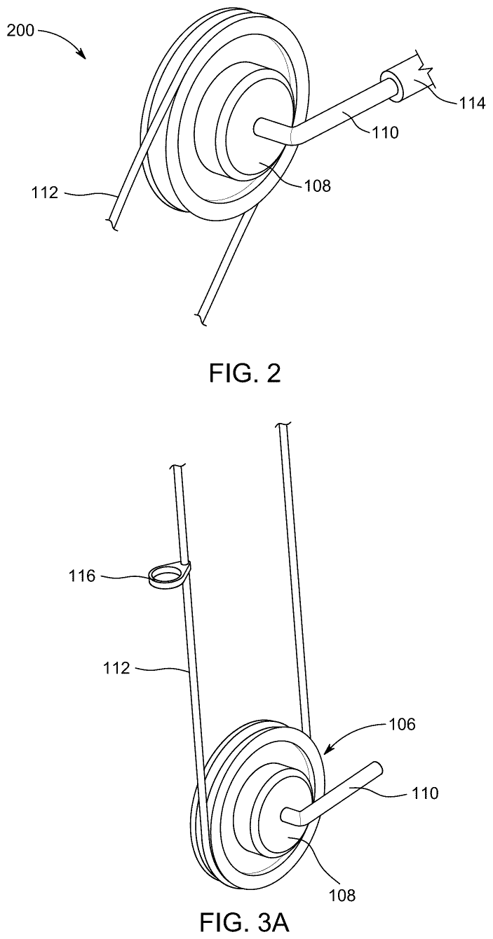

FIG. 2 is an isometric view of at least one pulley 200, in accordance with an example embodiment of the present disclosure. FIG. 2 is described in conjunction with FIGS. 1A-1B.

The at least one pulley 200 may comprise the at least one centrifugal brake 108. The at least one centrifugal brake 108 may be housed within the at least one pulley 200 to control the movement of the at least one pulley 200 and thereby the plurality of pulleys 106. The at least one centrifugal brake 108 may operate automatically by utilizing the centrifugal force acting on the at least one pulley 200 during the rotation of the plurality of pulleys 106. In some embodiments, the at least one centrifugal brake 108 may have revolving brake shoes (not shown) or referred as driving members, that may be driven outwards by the centrifugal force in contact with a fixed brake drum (not shown) or referred as driven member. The revolving brake shoes may have springs (not shown) loaded that may rotate along the brake shoes. In some instances, when the at least one pulley 200 rotates above a certain speed that is excessive than required, the revolving brake shoes are driven outwards by the centrifugal force and the springs may exert force to the fixed brake drum towards periphery of the at least one pulley 200. Such kinetic energy exerted over the at least one pulley 200 by revolving brake shoes may decelerate the at least one pre-tensioned rope 112 wound over the at least one pulley 200.

Further, the at least one pulley 200 may comprise the at least one tensioner 114 that is configured to maintain proper alignment and tension within the at least one pre-tensioned rope 112. In some embodiments, the at least one tensioner 114 may comprise at least one tensioner sensor (not shown). The at least one tensioner sensor may be configured to measure tension applied over the at least one pre-tensioned rope 112. In some embodiments, the at least one tensioner sensor may transmit signal to the at least one tensioner 114 to increase or decrease tension in the at least one pre-tensioned rope 112. In some example embodiments, the tension in the at least one pre-tensioned rope 112 may be in a range of 35-35 Newtons (N).

Referring to FIGS. 3A-3C, the at least one coupling hook 116 may be rigidly coupled to the at least one pre-tensioned rope 112 that is installed over the plurality of pulleys 106, in accordance with an example embodiment of the present disclosure.

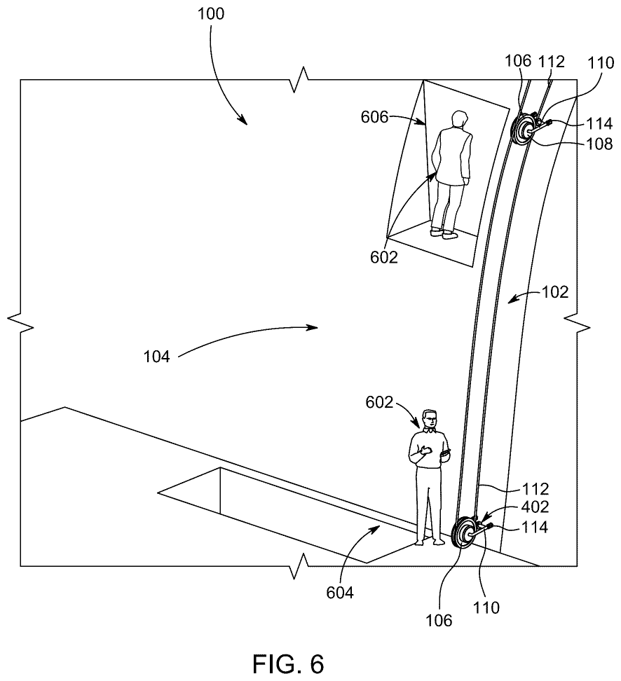

In some embodiments, the at least one coupling hook 116 may be referred as a fastening hook or a Carabiner. The at least one coupling hook 116 may comprise at least two annular sections 302. Further at least one annular section of the at least two annular sections 302 may be rigidly coupled to the at least one pre-tensioned rope 112 and other annular section of the at least two annular sections 302 may be detachably coupled to at least one lanyard 304. In some embodiments, the at least one annular section of the at least two annular sections 302 may have smaller diameter than other. It may be noted that the annular section of the at least two annular sections 302 rigidly coupled to the at least one pre-tensioned rope 112 may have smaller diameter than the annular section to be detachably coupled to the at least one lanyard 304. The at least one lanyard 304 may be configured to attach the user with the at least one coupling hook 116 to allow the user to move in any direction (i.e., 0-360 degrees relative to the horizontal plane). In this configuration, the at least one coupling hook 116 may be responsible for handling the user's position by the rotation of the plurality of pulleys 106. In some embodiments, the at least one coupling hook 116 may be made from a material selected from a group of materials of stainless steel, brass, and other alloy steels. It will be apparent that the rigid connection of the at least one coupling hook 116 with the at least one pre-tensioned rope 112 may facilitate the movement of the user with respect to the rotation/movement of the at least pre-tensioned rope 112, by keeping the at least one coupling hook 116 fixedly positioned at a coupling point. Stated differently, the at least one coupling hook 116 may be rigidly coupled to the pre-tensioned rope 112 such that the at least one coupling hook 116 moves with the pre-tensioned rope 112. The movement of the user along the pre-tensioned rope 112 is described later in conjunction with FIGS. 5A-8.

Referring to FIG. 3C, the at least one lanyard 304 may be coupled at one end to the at least one coupling hook 116 and at other end to a harness (not shown) that may be worn by a user. In some embodiments, the at least one lanyard 304 may correspond to a belt having a fastening hook 306 at one end that is coupled to the at least one coupling hook 116 and a belt clamp 308 at other end that is coupled to the harness of the user. It may be noted that length of the at least one lanyard 304 may be adjusted according to height and working space of the user. The length of the at least one lanyard 304 may be adjusted using the belt clamp 308.

Further, the at least one lanyard 304 may comprise a shock absorber 310. In some embodiments, the shock absorber 310 may be fabricated along the length of the at least one lanyard 304. The shock absorber 310 may be configured to prevent the user from an injury by absorbing kinetic energy experienced by the user in case of a fall. In some embodiments, the shock absorber 310 may be made from a material from a group of polymeric materials having reinforced with elastomeric properties like rubber. The shock absorber 310 may absorb shocks while the user slides or skids along the mounting area 102 of the structure 104.

FIG. 4 illustrates an isometric view of a portion of the fall arrest system 100 having the at least one pre-tensioned rope 112 wrapped around the plurality of pulleys 106 with at least one auxiliary pulley 402 to maintain contact of the at least one pre-tensioned rope 112 with the plurality of pulleys 106, in accordance with another embodiment of the present disclosure.

The fall arrest system 100 may comprise the at least one auxiliary pulley 402 that may be arranged with the plurality of pulleys 106 to maintain the contact of the at least one pre-tensioned rope 112 with the plurality of pulleys 106 over the mounting area 102. At least one auxiliary pulley 402 may be coupled to a respective holder 110 and positioned between a pulley 106 and the mounting area 102 onto which the holder 110 is mounted. In various examples, at least one auxiliary pulley 402 may be coupled to a respective holder 110, and a pulley 106 may be positioned between the auxiliary pulley 402 and the mounting area 102 onto which the holder 110 is mounted. It may be noted that the periphery of the plurality of pulleys 106 may have contact with a periphery of respective at least one auxiliary pulley 402, so that the at least one pre-tensioned rope 112 may be in contact with the plurality of pulleys 106. Each of the at least one auxiliary pulley 402 may be positioned near, or in direct contact with, a respective pulley of the plurality of pulleys 106 to maintain proper alignment of the at least one pre-tensioned rope 112 with each of the plurality of pulleys 106.

In some embodiments, one or more users may perform jobs over the structure 104 by using at least two pre-tensioned ropes 112 that may be wound around at least two pulleys of the plurality of pulleys 106 mounted over the mounting area 102. In such case, the at least two pulleys may be aligned with each other at periphery of the at least two pulleys. Also, one holder may be used to mount a pulley of the at least two pulleys that is proximal to the mounting area 102. Another holder may be used for a pulley of the at least two pulleys that is distal to the mounting area 102, to be coupled with the one holder. In some embodiments, two auxiliary pulleys may be coupled with a first auxiliary pulley coupled between the mounting area 102 and the pulley proximal to the mounting area 102. A second auxiliary pulley may be coupled between the at least two pulleys. Such mechanism of a fall arrest system may facilitate the one or more users to perform specific tasks/jobs over the structure 104.

FIG. 5 illustrates the at least one tensioner 114, in accordance with another embodiment of the present disclosure.

The at least one tensioner 114 may comprise an elongated shaft 502 having a spring 504 loaded at one end and one or more clamps 506 at other end. The spring 504 may be positioned between at least two annular rings 508 that may slide along the length of the elongated shaft 502. Further, at least two nuts 510 may be mounted towards the one end of the elongated shaft 502. The at least two nuts 510 may be screwed towards the other end of the elongated shaft 502 to hold compression of the spring 504 between the at least annular rings 508. Further, the one or more clamps 506 may be coupled to the at least one pulley of the plurality of pulleys 106. Therefore, when the plurality of pulleys 106 rotate either in clockwise or counterclockwise rotation, the spring 504 is compressed by virtue of motion of the at least two annular rings 508 towards each other. In this manner, the at least one pre-tensioned rope 112 loosened over the plurality of pulleys 106 are pulled to be stretched and thereby maintain tension. In some embodiments, the at least one tensioner 114 may create a tension of more than 1500 N within the spring 504.

As discussed, the at least one tensioner 114 may be provided with the at least one tensioner sensor that may measure tension within the at least one pre-tensioned rope 112. It will be apparent that the tension within the at least one pre-tensioned rope 112 may be decreased when the user is clamped to the fall arrest system 100 using the at least one coupling hook 116. Any change in the required tension of the at least one pre-tensioned rope 112 may be adjusted instantaneously after being detected by the at least one tensioner sensor.

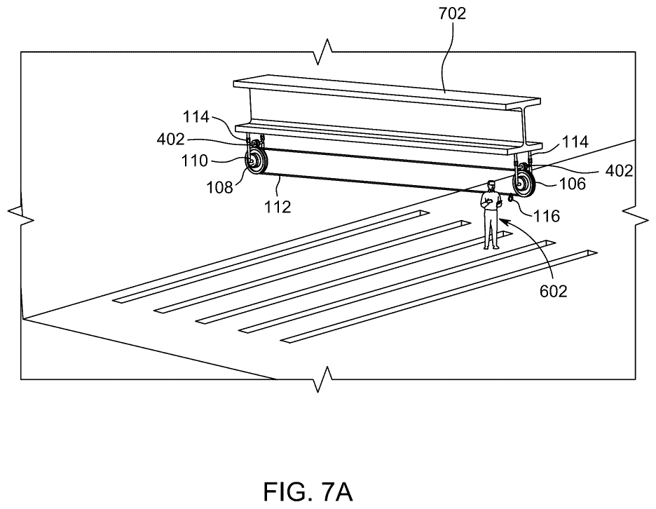

FIG. 6 illustrates an exemplary scenario of the fall arrest system 100 installed over the structure 104, in accordance with another embodiment of the present disclosure.

The plurality of pulleys 106 may be mounted over the mounting area 102 of the structure 104 using the plurality of holders 110. The at least one pre-tensioned rope 112 may be wrapped around the plurality of pulleys 106 and the at least one coupling hook 116 may be fastened to the at least one pre-tensioned rope 112 at the coupling point. A user 602 may couple the at least one lanyard 304 to the at least one coupling hook 116. The plurality of pulleys 106 may be rotated using an accelerator device (not shown) that may set motion within the at least one pre-tensioned rope 112. Further, the user may start moving safely from a start point 604 to a designated point 606 over the structure 104 by rotation of the plurality of pulleys 106 along with at least one pre-tensioned rope 112. In some embodiments, the at least one centrifugal brake 108 may be applied instantaneously once the user reaches to the designed point 606. It may be noted that the at least one centrifugal brake 108 may be applied automatically based on the predetermined centrifugal force achieved by the springs that may exert force to the fixed brake drum towards periphery of the at least one pulley 200. It will be apparent that the at least one tensioner 114 may adjust the tension in the at least one pre-tensioned rope 112 continuously.

Further, the user 602 may have the flexibility to move from the start point 604 to the designated point 606 and back along with the at least one pre-tensioned rope 112 to cover 360° range. Such flexibility of the user may adjust one of the plurality of holders 110 mounted over the mounting area 102 to orient at the first angle relative to the horizontal plane and one of the plurality of holders 110 at the second angle relative to the horizontal plane. The first angle and the second angle relative to the horizontal plane on either side of the mounting area 102 may have a difference of at least 15 degrees.

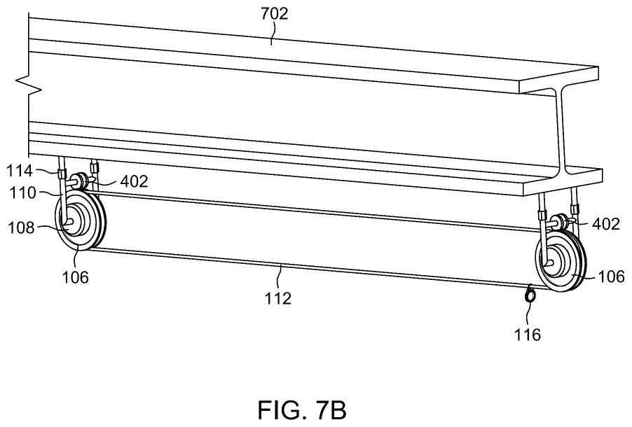

FIGS. 7A-7B illustrate exemplary scenarios of the fall arrest system 100 welding on a beam 702, in accordance with an example embodiment of the present disclosure.

The plurality of pulleys 106 are mounted along the length of the beam 702 using the plurality of holders 110. At least two auxiliary pulleys 402 may be assembled in contact with the plurality of pulleys 106 to align the at least one pre-tensioned rope 112 within the plurality of pulleys 106. In some embodiments, the beam 702 may be inclined at a certain height parallel to the ground or at a certain angle on the structure 104. The user 602 may attach himself/herself to the at least one coupling hook 116 of the at least one pre-tensioned rope 112 via the at least one lanyard 304. The plurality of holders 110 may be hold the plurality of pulleys 106 to the beam 702 so that the user 602 may move from one place to other along the beam 702. It may be noted that the at least one centrifugal brake 108 may be applied at any point along the beam 702. The user 602 may have a flexibility to move on either side of the beam 702 to perform operations, like welding etc. In some embodiments, under the effect of gravity and the user's 602 weight, the at least one pre-tensioned rope 112 may be pulled downwards. The at least one tensioner 114 may maintain equal tension within the at least one pre-tensioned rope 112 along the length of the beam 702, so that the user 602 coupled to the at least one pre-tensioned rope 121 may have a smooth movement.

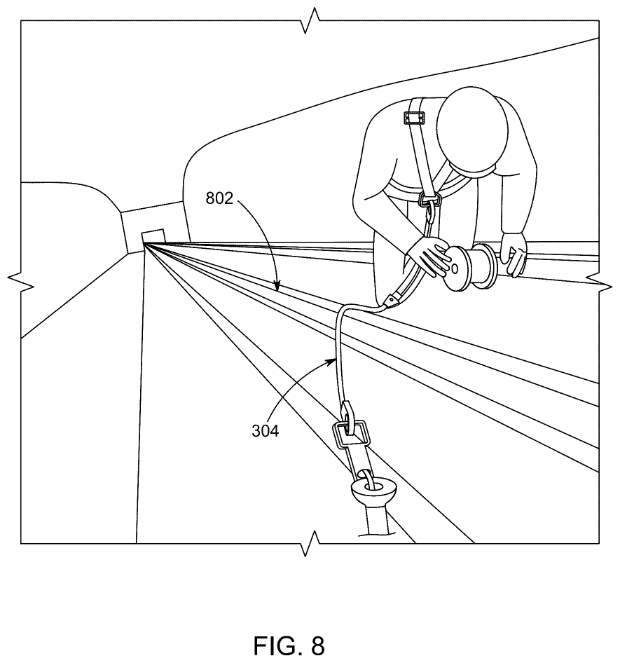

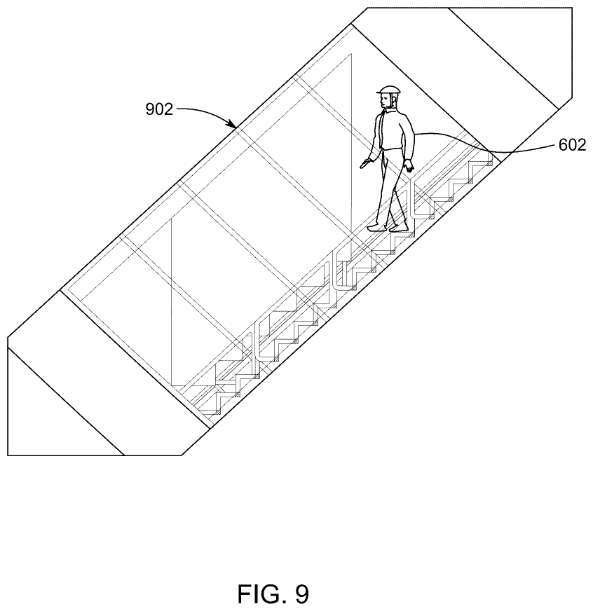

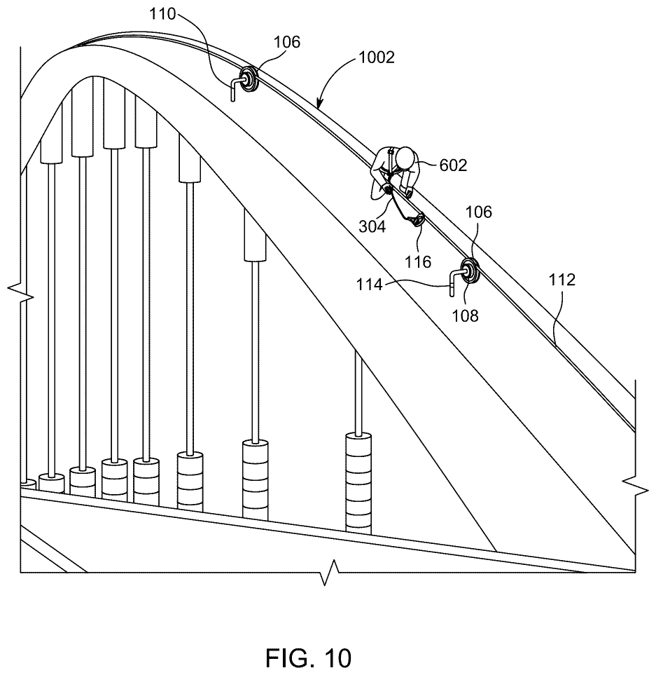

FIG. 8 illustrates another exemplary scenario of the fall arrest system 100 installed on a railway track 802, in accordance with another example embodiment of the present disclosure. FIG. 9 illustrates another exemplary scenario of the fall arrest system 100 installed on a slope structure 902, in accordance with another example embodiment of the present disclosure. FIG. 10 illustrates another exemplary scenario of the fall arrest system 100 installed on a bridge structure 1002, in accordance with another example embodiment of the present disclosure.

The fall arrest system 100 installed on the railway track 802 may provide 360-degrees movement to the user on the railway track 802, the slope structure 902, and the bridge structure 1002. In some embodiments, the fall arrest system 100 may be a safety mechanism designed to protect the user 602 from falling from the elevated surfaces. It may be noted that the railways track 802 may not be typically elevated, however, there may be situation where the fall arrest system 100 may be necessary, such as when working on bridges, elevated platforms, or maintenance activities near railway lines. Further, the fall arrest system 100 provides complete safety to workers. Also, before a work begins near railways tracks, a thorough risk assessment may be conducted to identify all potential fall hazards, such as elevated platforms, bridges, or area with unprotected edges. Also, follow safe work procedures, and maintain a safe distance from the edge or any potential fall hazard, and maintain three-points contact when working on elevated surfaces, or while working near the railway tracks.

In some example embodiments, the fall arrest system 100 used on the slope structure 902 and bridge structure 1002 may be a crucial task for the safety of the user 602 when performing tasks on inclined surface. In some embodiments, the fall arrest system 100 may be used by conducting the thorough risk assessment to identify fall hazards on the slope structure 902, and determine a degree of slope and its impact on the work, and further identify anchor points or suitable location for securing the fall arrest system 100.

In some embodiments, the fall arrest system 100 may allow the user to climb over different structures such as buildings, bridges, inclined railways tracks, inclined structures etc. Further, the fall arrest system may provide both vertical movement and horizontal movement over the structure to the user. Further, the fall arrest system 100 may be configured to be installed over the wall or a stable ground without having a range limitation. Further, the fall arrest system 100 may prevent the user from falling in accidental situations and prevent the user from an injury. In some embodiments, the fall arrest system 100 may be used over a bridge, railway track, building etc. for conducting maintenance work.

As will be appreciated the fall arrest system 100 has various benefits. For example, and as discussed, each of the plurality of holders 110 may be configured to be mounted to a respective mounting area 102, which can have a surface that extends at any angle (e.g., 0-360 degrees) relative to the horizontal plane. Also, the fall arrest system 100 may have at least one holder 110 that is mounted to a respective mounting area 102 that has a surface that extends at an angle that is different (e.g., at least 15 degrees different) than a surface of another mounting area 102 onto which another holder 110 is mounted. This configuration may result in a fall arrest system that is flexible regarding what surfaces and structures that the fall arrest system 100 may be mounted to. Also, the fall arrest system 100 may be easily reconfigured for the particular scenario that the fall arrest system 100 is to be used on. Therefore, designing or installing a custom fall arrest system for a particular scenario may be unnecessary, which may reduce costs or reduce planning time prior to installing a fall arrest system.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A fall arrest system comprising:
a plurality of pulleys, wherein at least one of the plurality of pulleys comprises at least one centrifugal brake;
a plurality of holders, each holder being coupled to a pulley of the plurality of pulleys and configured to mount the respective pulley onto a mounting area of a structure or the ground;
at least one pre-tensioned rope wrapped around the plurality of pulleys and configured to rotate along the plurality of pulleys; and
at least one coupling hook rigidly coupled to the at least one pre-tensioned rope.

2. The fall arrest system of claim 1, wherein at least one auxiliary pulley is arranged with at least one of the plurality of pulleys and is configured to maintain contact of the at least one pre-tensioned rope with the plurality of pulleys.

3. The fall arrest system of claim 1, wherein the at least one centrifugal brake actuates automatically by utilizing centrifugal forces to prevent free fall of the user from the mounting area.

4. The fall arrest system of claim 1, wherein each of the plurality of holders is configured to be mounted to the respective mounting area regardless of the orientation of the respective mounting area.

5. The fall arrest system of claim 1, wherein at least one tensioner is installed with the at least one of the plurality of pulleys and configured to maintain alignment and tension of the at least one pre-tensioned rope.

6. The fall arrest system of claim 5, wherein the at least one tensioner has a spring loaded arm configured to apply pressure and align the at least one pre-tensioned rope along the plurality of pulleys.

7. The fall arrest system of claim 5, wherein at least one tensioner sensor is coupled to the at least one tensioner and configured to measure tension applied over the at least one pre-tensioned rope.

8. The fall arrest system of claim 1, wherein the at least one coupling hook has at least two annular sections, at least one annular section is rigidly coupled to the at least one pre-tensioned rope and the other annular section is detachably coupled to at least one lanyard.

9. The fall arrest system of claim 8, wherein the at least one lanyard is configured to attach the user with the at least one coupling hook.

10. The fall arrest system of claim 8, wherein the at least one lanyard is integrated with a shock absorber that is configured to absorb kinetic energy experienced by the user in case of a fall.

11. The fall arrest system of claim 1, wherein at least one of the plurality of holders is coupled to the mounting area that is oriented at a first angle relative to a horizontal plane and another one of the plurality of holders is coupled to the mounting area that is oriented at a second angle relative to the horizontal plane, wherein the first angle is at least 15 degrees greater than the second angle.

12. A fall arrest system comprising:
a plurality of pulleys, wherein at least one of the plurality of pulleys comprises at least one centrifugal brake;
a plurality of holders, each holder being coupled to a pulley of the plurality of pulleys and configured to mount the respective pulley onto a mounting area of a structure or the ground;
at least one pre-tensioned rope wrapped around the plurality of pulleys and configured to rotate along the plurality of pulleys;
at least one tensioner coupled to at least one of the plurality of pulleys and configured to maintain tension in the at least one pre-tensioned rope; and
at least one coupling hook rigidly coupled to the at least one pre-tensioned rope.

13. The fall arrest system of claim 12, wherein at least one auxiliary pulley is arranged with at least one of the plurality of pulleys and is configured to maintain contact of the at least one pre-tensioned rope with the plurality of pulleys.

14. The fall arrest system of claim 12, wherein the at least one centrifugal brake actuates automatically by utilizing centrifugal forces to prevent free fall of the user from the mounting area.

15. The fall arrest system of claim 12, wherein each of the plurality of holders is configured to be mounted to the respective mounting area regardless of the orientation of the respective mounting area.

16. The fall arrest system of claim 12, wherein the at least one tensioner having a spring loaded arm configured to apply pressure and align the at least one pre-tensioned rope along the plurality of pulleys.

17. The fall arrest system of claim 16, wherein at least one tensioner sensor is coupled to the at least one tensioner and configured to measure tension applied over the at least one pre-tensioned rope.

18. The fall arrest system of claim 12, wherein the at least one coupling hook having at least two annular sections, at least one annular section is rigidly coupled to the at least one pre-tensioned rope and other annular section is detachably coupled to at least one lanyard.

19. The fall arrest system of claim 18, wherein the at least one lanyard is configured to attach the user with the at least one coupling hook, wherein the at least one lanyard is integrated with a shock absorber that is configured to absorb kinetic energy experienced by the user in case of a fall.

20. The fall arrest system of claim 12, wherein at least one of the plurality of holders is coupled to the mounting area that is oriented at a first angle relative to a horizontal plane and another one of the plurality of holders is coupled to the mounting area that is oriented at a second angle relative to the horizontal plane, wherein the first angle is at least 15 degrees greater than the second angle.
